(19) United States
(12) Patent Application Publication
(10) Pub. No.: US 2014/0147721 A1
(43) Pub. Date: May 29, 2014

(54) BATTERY MODULE

(71) Applicant: Yoshihide Kurahashi, (US)

(72) Inventor: Tomoyoshi Kurahashi, Tokyo (JP)

(73) Assignee: MITSUBISHI HEAVY INDUSTRIES, LTD., Tokyo (JP)

(21) Appl. No.: 13/817,753

(22) PCT Filed: Nov. 4, 2011
(86) PCT No.: PCT/JP2011/075426

§ 371 Date: Feb. 19, 2013

(30) Foreign Application Priority Data
Nov. 9, 2010 (JP) 2010-251125

(51) Int. Cl. H01M 10/42

(52) U.S. Cl. CPC H01M 10/425
USPC 429/121

(57) ABSTRACT

A battery module (100) of the present invention includes a battery cell (1) and an attachment (2). The battery cell (1) has an electro-conductive battery case (7), an electrode terminal (8) that is exposed outside the battery case (7), and electrode plates (3). The attachment (2) has a first conducting section (81), a second conducting section (82), and a resistive material (83) that is disposed between the first conducting section (81) and the second conducting section (82) and that is electrically connected to the first conducting section (81) and the second conducting section (82). The attachment (2) is attached to the electrode cell (1), and the first conducting section (81) is electrically connected to the battery case (7) and the second conducting section (82) is electrically connected to the electrode terminal (8) automatically at the time of attachment.

### FIELD OF THE INVENTION

The present invention relates to a battery module.

Priority is claimed on Japanese Patent Application No. 2010-251125 filed on Nov. 9, 2010, the content of which is incorporated herein by references.

### BACKGROUND ART

A battery cell is used in various electric systems such as electric vehicles, stationary battery devices, stationary power supplies, and electric generators. A battery cell includes a battery case that stores an electrolyte solution, electrode terminals disposed onto the battery case, and electrode plates that are stored in the battery case and are connected to the electrode terminals.

In some case, the above-described battery case is made of metallic material such as aluminum. Where the battery cell is made of metal, there is a possibility that a portion of the battery case being in contact with the electrolyte solution is alloyed by trapping ions in the electrolyte solution, thereby resulting in deterioration of the battery case and/or the electrolyte solution. Based on the consideration of a way to avoid such disadvantage, a battery cell is proposed as disclosed in Patent Reference 1 in which a battery case is electrically connected to the electrode terminals via resistive elements or the like as electric current confinement units. According to such conventional art, electric potential of the battery case is maintained at the electric potential of the electrode terminal connected to the battery case, and ions in the electrolyte solutions are not likely to be trapped in the battery case.

### PRIOR ART DOCUMENT

### Patent Document

Patent Document 1: Japanese Unexamined Patent Application, First Publication, No. 2010-33777.

### SUMMARY OF THE INVENTION

### Problems to be Solved by the Invention

In the above-described conventional arts, the current confinement unit is an accessory part which is small enough to be disposed between the electrode terminal and the battery case. One end of the current confinement unit is fixed to the electrode terminal and the other end is fixed to the battery case by screw thread or the like so as to electrically connect the electrode terminal and the battery case. Fixing of the current confinement unit that is formed as a small accessory part requires delicate technique and may cause a reduction of production efficiency.

Where the conventional battery cell is used in the electronic system, for example, in the electronic vehicle, the current confinement unit may be detached from the electrode terminal or the battery case due to, for example, loosening of the fixture caused by vibration or the like. As a result, there is a possibility of deterioration of the performance of the battery cell.

Based on the consideration of the above-described circumstance, an object of the present invention is to provide a battery module having excellent battery performance while improving the production efficiency.

### Solutions of the Problems

A battery module of the present invention includes: a battery cell having an electro-conductive battery case, an electrode terminal that is exposed outside the battery case, and electrode plates; and an attachment that has a first conducting section, a second conducting section, and a resistive body that is disposed between the first conducting section and the second conducting section and that is electrically connected to the first conducting section and the second conducting section, wherein the attachment is attached to the electrode cell, and the first conducting section is electrically connected to the battery case and the second conducting section is electrically connected to the electrode terminal automatically at the time of attaching the attachment.

According to the above-described constitution, the electrode terminal (positive electrode terminal or negative electrode terminal) and the electro-conductive battery case are electrically connected via the resistive body automatically by one touch operation by overlaying the attachment on the battery cell, and pressing and thereby fixing the attachment.

### Effect of the Invention

According to the present invention, it is possible to provide a battery module having excellent battery performance while improving the production efficiency.

### BRIEF EXPLANATION OF DRAWINGS

FIG. 1 is a schematic diagram that shows a constitution of a battery module of the first embodiment.

FIG. 2 is a diagram that shows a cross sectional structure along line A-A′ of the battery module of FIG. 1

FIG. 3 is a diagram that shows a cross sectional structure along line B-B′ of the battery module of FIG. 1, where A is a cross sectional structure in the case of attaching the attachment to the battery cell, and 13 is a cross sectional structure at a state directly before attaching the attachment to the battery cell.

FIG. 4 is a diagram that shows a modified embodiment (modified embodiment 1) of the battery module shown in FIG. 1.

FIG. 5 is a diagram that shows a modified embodiment (modified embodiment 2) of the battery module shown in FIG. 1.

FIG. 6 is a schematic diagram that shows a constitution of a battery module of a second embodiment.

### MODE FOR CARRYING OUT THE INVENTION

In the following, embodiments of the present invention will be explained with reference to drawings. In the drawings used in the explanation, measurements and scales of respective structures are occasionally modified from the practical values. In the below described embodiments, similar constitutions are illustrated with the same reference signs such that a repeated explanation may be omitted.

### First Embodiment

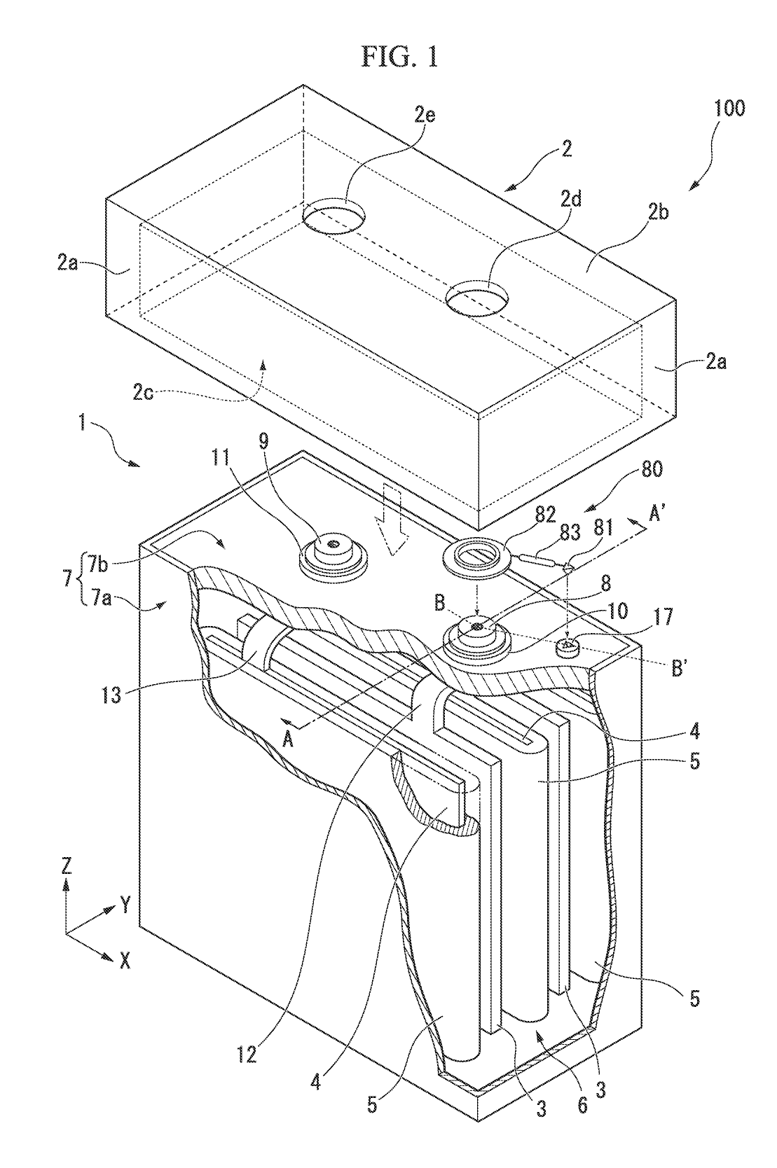

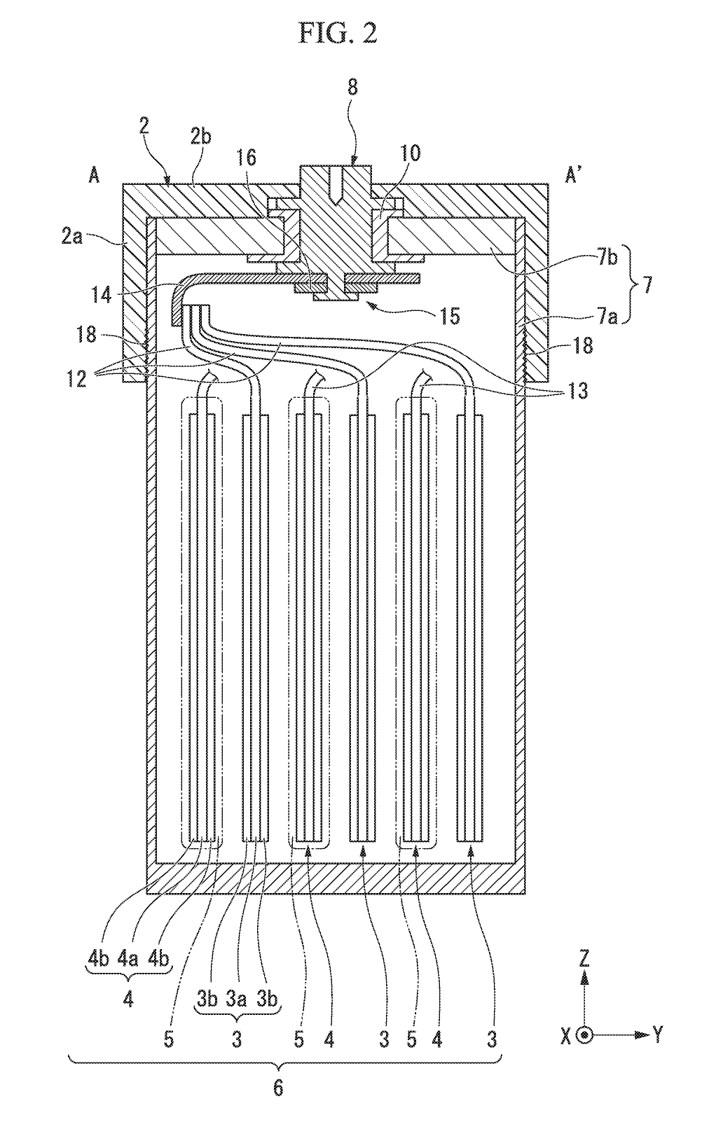

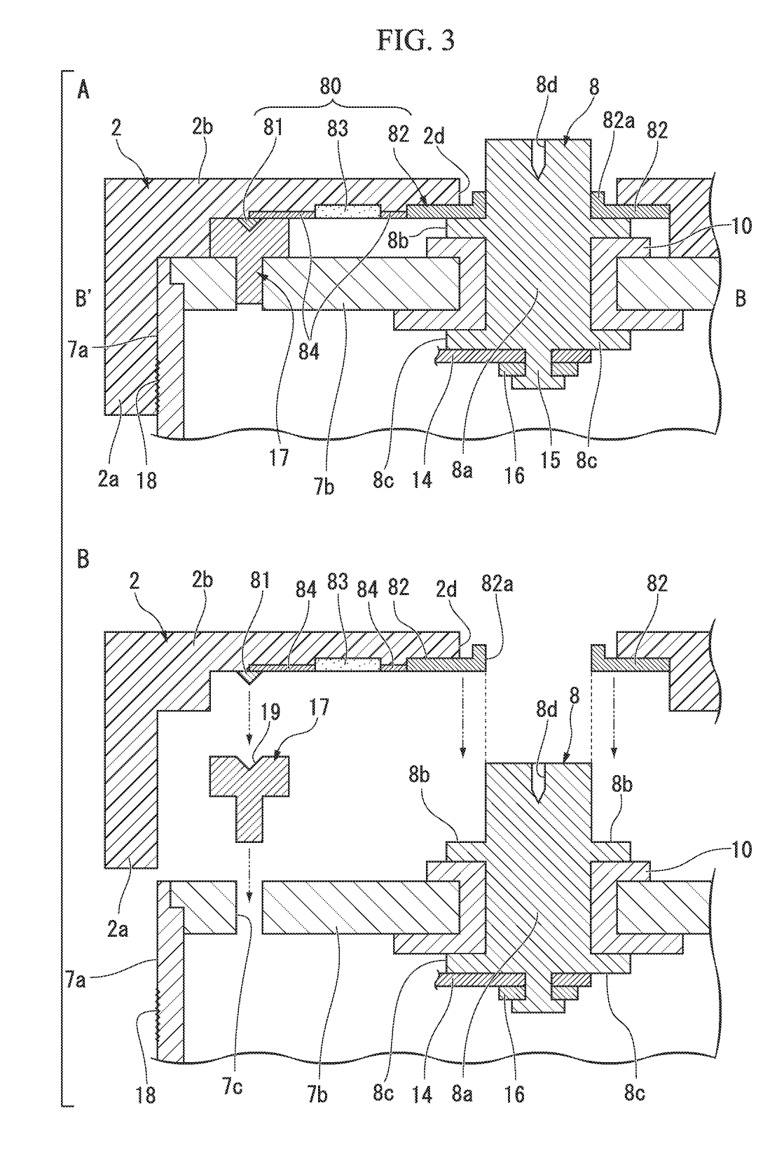

FIG. 1 is a schematic diagram that shows a constitution of a battery module of the present embodiment. FIG. 2 is a diagram of a cross sectional structure along line A-A′ shown in FIG. 1. FIGS. A and B of FIG. 3 are diagrams of a cross sectional structure along line B-B′ shown in FIG. 1. Where a coordinate systems are shown in the below explained drawing, the coordinate systems belongs to the same rectangular coordinate system.

A battery module 100 of the present embodiment is constituted of a combination of a battery cell 1 and an attachment 2. The battery cell 1 is, for example, a lithium-ion rechargeable battery. Here, the battery cell 1 is illustrated as a stacked type battery cell.

The electrode terminal (positive electrode terminal or negative electrode terminal) on one end of the battery cell 1 and the battery case made of metal are electrically connected via a resistive body 83 automatically by one touch operation by overlaying the attachment 2 on the battery cell 1, and pressing and thereby fixing (hereafter, referred to as attaching) the attachment 2 to the battery cell 1. A detailed explanation is described below.

Firstly, a schematic constitution of the electrode cell 1 is explained. As shown in FIG. 1 and FIG. 2, the stacked type battery cell 1 has a constitution such that a plurality of sheet shaped cathode plates 3 and a plurality of sheet shaped anode plates 4 are stacked alternately via a separator 5 (here, a bag (capsule) shaped separator that encloses each anode plate 4) to constitute a stacked electrode body 6, and the stacked electrode body 6 is, without being rolled up, installed in an electro-conductive battery case (for example, a battery case made of metal such as aluminum). The constituent members of the battery case 7 are case main body 7a having an opening, and a lid 7b that closes the opening. After installing the stacked electrode body 6 in the interior of the battery case main body 7a, the battery case 7 is sealed by closing the opening with the lid 7b and welding the lid 7b (even though it is not shown in the drawing, resin sheet or the like having insulation properties is disposed between the stacked electrode body 6 and the battery case 7). The battery case 7 is arranged in FIG. 1 such that the long-side of substantially rectangular bottom plane is aligned in the direction of X-axis, and the short-side of the bottom plane is aligned in the direction of Y-axis, and the height direction of the case main body 7a is aligned in the Z direction.

Electrode terminals (cathode terminal 8 and anode terminal 9) are arranged such that ends of the two electrode terminals protrude from the both end portions of the face of the lid 7b through the penetration holes formed in the lid 7b, and are fixed and integrated to the lid 7b by the insulation resins (insulation resin 10 for the cathode terminal and insulation resin 11 for the anode terminal) that are disposed between the electrode terminals and the lid 7b such that the electrode terminals and the lid 7b are not electrically connected.

A liquid pouring hole 7c (see FIG. 3) is formed in the lid 7b, through which electrolyte solution (not shown) is filled in the interior of the battery case 7. FIG. 1 shows a sealing section 17 that is made of metal and is constituted as a screw or the like to seal the liquid pouring hole.

Each of the electrode terminals (cathode terminal 8 or anode terminal 9) is electrically connected to the electrode plates (cathode plates 3 or anode plates 4) via corresponding electrode lead (cathode lead 14 or anode lead). In the cathode plate 3, cathode active material 3b such as lithium manganese oxide is coated on both faces of substantially rectangular cathode collector 3a made of aluminum or the like. In the anode plate 4, anode active material 4b such as carbon or the like is coated on both faces of substantially rectangular anode collector 4a made of copper or the like. The cathode tab 12 is a portion of the cathode collector 3a, and anode tab 13 is a portion of the anode collector 4a.

Practically, as shown in FIG. 2, cathode tabs 12 of the plurality of cathode plates 3 are bundled and fixed to an end (first end) of the band shaped cathode lead 14 by ultra-sonic welding or the like, and the other end (second end) of the lead is fixed to the cathode terminal 8. A penetration hole is formed in the second end. One end of the cathode terminal 8 is disposed inside the battery case 7, and a columnar securing member 15 is provided to this end. The securing member 15 is inserted into the penetration hole of the cathode tab 12. After that, securing aid 16 such as a washer or the like is fitted to the securing member 15, and subsequently, the cathode lead 14 is fixed to the cathode terminal 8 by the securing member 15. For example, where the securing member 15 is a rivet that is formed integrally with the cathode terminal 8, the fixing is performed by clinching an end of the rivet. Where the securing member 15 is an external screw thread formed independent of the cathode terminal 8, the fixing is performed by screwing the external screw thread to a thread hole formed in the cathode terminal 8.

Connection of the anode terminal 9 and the anode lead is performed in the same manner as the above-described connection of the cathode terminal 8 and the cathode lead 14. Therefore, explanation for the connection of the anode terminal 9 and the anode lead is omitted. In the above-described constitution, the electrode terminal is electrically connected to the electrode plates using an electrode lead. In an alternative constitution, a hole similar to the above-described penetration hole may be formed in each of the electrode tabs so as to fix a plurality of electrode tabs directly to the corresponding electrode terminal in the same manner as described above. Explanation for the characteristic shapes of the electrode terminals and their effects will be described below.

Next, attachment 2 is explained. The attachment 2 has an attachment-ceil plate 2b that has a shape of substantially rectangular plate and that is disposed such that the planar surface is arranged in the XY plane, an attachment-side part 2a that is connected to the whole periphery of the attachment-ceil plate 2b and that extends from the whole periphery towards the direction (−Z direction) substantially normal to the planer surface of the attachment ceil plate 2b; and a resistance section 80 that is embedded and fixed in the attachment ceil plate 2b. That is, the resistance section 80 is integrated with the attachment 2.

The attachment-side part 2a and the attachment-ceil plate 2b are made of elastic material, for example, silicone rubber or plastic resin that can be deformed elastically. The attachment-side part 2a and the attachment ceil plate 2b may be formed integrally by molding or the like. Penetration holes (cathode terminal penetration hole 2d and anode terminal penetration hole 2e) are formed in the attachment ceil plate 2b such that the cathode terminal 8 and the anode terminal 9 are inserted therethrough.

The resistance section 80 includes a first conducting section 81 that is made of metal and is in physical contact with the sealing section 17, and a second conducting section 82 that is in physical contact with the cathode terminal 8, a resistive body 83 that is disposed between the first conducting section 81 and the second conducting section 82 and is connected to the first conducting section 81 and the second conducting section 82 and provides high resistance to the electric path between the first conducting section 81 and the second conducting section. The resistive body 83 may be physically connected to the first conducting section 81 and the second conducting section 82 directly, or may be connected to the first conducting section 81 and the second conducting section 82 directly via a wiring 84 (see FIG. 3). Although the resistance section 80 is illustrated separately from the attachment ceil plate 2b for the sake of better understanding, the resistance section 80 is embedded and fixed in the attachment ceil plate 2b as explained above. As an alternative to the embedded constitution, the resistance section 80 may be fixed to the attachment ceil plate 2b or the attachment-side part 2a using an insulating adhesive or the like if the fixing can be performed securely.

A cross-section on XY plane of the recess 2c surrounded by the attachment-side part 2a has substantially the same shape as the cross-sectional shape of the battery cell 1 along XY plane or has a shape that is analogous but is slightly smaller than the cross-sectional shape of the battery cell 1 along XY plane. Therefore, at the time of securely overlaying the attachment 2 on the battery cell 1, that is, at the time of overlaying the attachment 2 to the battery cell 1 to constitute the battery module 100 such that electric path is formed between the cathode terminal 8 and the battery case 7 via the resistance section 80 of the attachment 2, the attachment-side part 21 made of the above-described elastic material is deformed in accordance with the shape of the battery case 7a of the battery cell 1 and compresses the electrode cell 1 by its bouncing force, thereby fixing the attachment 2 to the electrode cell 1. In addition, since the attachment-side part 2a is made of the elastic material, there is an additional effect that the attachment 2 is not likely to be detached from the electrode cell 1 due to frictional force between the elastic material and the battery case 7.

In the portion to be in contact with the attachment-side part 2a, the surface of the battery case 7a may be roughened, for example, by sand blasting or the like so as to enhance the frictional force (where the portion of the enhanced frictional force is referred to as frictional portion 18). The frictional portion 18 may be formed in the portion of the attachment-side part 2a to be in contact with the case main body 7a. That is, the portion for enhancing the frictional force may be formed in both of or only one of the attachment-side part 2a and the case main body 7a in accordance with the design option. Even though the frictional portion 18 is preferably formed throughout the whole periphery of the case main body 7a for the sake of the above-described enhancement, the frictional portion 18 may be formed in partial portion of the battery case 7a provided that sufficient enhancement is achieved.

A state of physical contact between the resistance section 80 of the attachment 2 and the battery case is explained in detail with reference to FIG. 3 that shows a cross sectional structure along line B-B′ of FIG. 1. For the sake of better understanding, figure A of FIG. 3 shows a state where a battery module is formed by overlaying the attachment 2 on the battery cell 1, and figure B of FIG. 3 shows a state just before overlaying the attachment 2 on the battery cell 1.

Firstly, the first conducting section 81 of the resistance section 80 is a metal having a protruding shape (for example, trigonal pyramid shown in the figure) and is arranged such that a top thereof faces an upper face of the sealing section 17 fixed to the battery cell 1.

A recess corresponding to the above-described protruding shape is formed in the upper face of the sealing section 17. For example, where the sealing section 17 is constituted of an external thread screw, the recess may be formed on the head of the screw. As an alternative to the drawn embodiment where the first conducting section 81 is formed to have a protruding, for example, trigonal pyramid shape, and a recess of corresponding shape is formed in the sealing section 17, it is acceptable to form the first conducting section 81 to have a recessed shape, and to form the sealing section 17 to have a corresponding protruding shape. The protruding or recessed shape formed in the sealing section 17 is referred to as an engagement 19.

A second conducting section 82 of the resistance section 80 is a platy metal member having substantially same or slightly larger analogous shape as the cross sectional shape in XY plane of the axial portion 8a of the cathode terminal 8. In the present embodiment, so as to improve electric-connection between the second conducting section 82 and the cathode terminal 8, the electrode terminal is given a specific shape as described in the following explanation.

In FIG. 1 to FIG. 3, the cathode terminal 8 has a columnar axial portion 8a, and further has a first connecting portion 8b constituted of a platy member that is joined to the axial portion 8a. Compared to the cross sectional shape (here, a circle) of the axial portion 8a, the first connecting portion 8b has a larger analogous shape (here, a circle having a diameter larger than the above-described circle) in XY plane. The first conducting portion 8b is designed to have a predetermined thickness (for example, about 3 mm) so as to have certain strength. Since the second conducting section 82 can be made contact both of the axial portion 8a and the first connecting section 8b, electric connection between the cathode electrode 8 and the second conducting section 82 is further improved compared to the case where the cathode terminal 8 is only constituted of the axial portion 8a. Especially, the above-described electric connection is further improved since the second conducting section 82 and the first connecting portion 8b are made contact in planer contact. That is, it is possible to reduce the value of resistance such as contact resistance in the electric path between the cathode terminal 8 and the cathode plate 3.

In the battery module 100 of the present embodiment, the second conducting section 82 has an increased area in the portion being in contact with the axial portion 8a such that the second conducting section 82 and the axial portion 8a are in contact with a plane. Practically, the thickness of a portion of the second conducting section 82 is increased in the periphery of the penetration hole (hereafter, referred to as the increased plate thickness portion 82a). Because of such a constitution, the above-described electric contact is further improved.

As shown in FIG. 1 to FIG. 3, a second connecting portion 8c having a constitution similar to that of the first connecting portion 8b may be formed in the (axial portion 8a: cathode terminal 8) with a predetermined space (a space larger than the thickness of the lid 7b) from the first connecting portion 8b. In this case, contact area between the cathode lead 14 and the cathode terminal 8 is increased since planer contact is made between the cathode lead 14 and the second connecting portion 8c. As a result, contact resistance between the cathode plate 3 and the cathode terminal 8 can be decreased. Therefore, a battery module 100 having further improved battery property can be provided. The axial portion 8a, the first connecting portion 8b, and the second connecting portion 8c may be made of the same material, and may be made integrally from the same material using a mold.

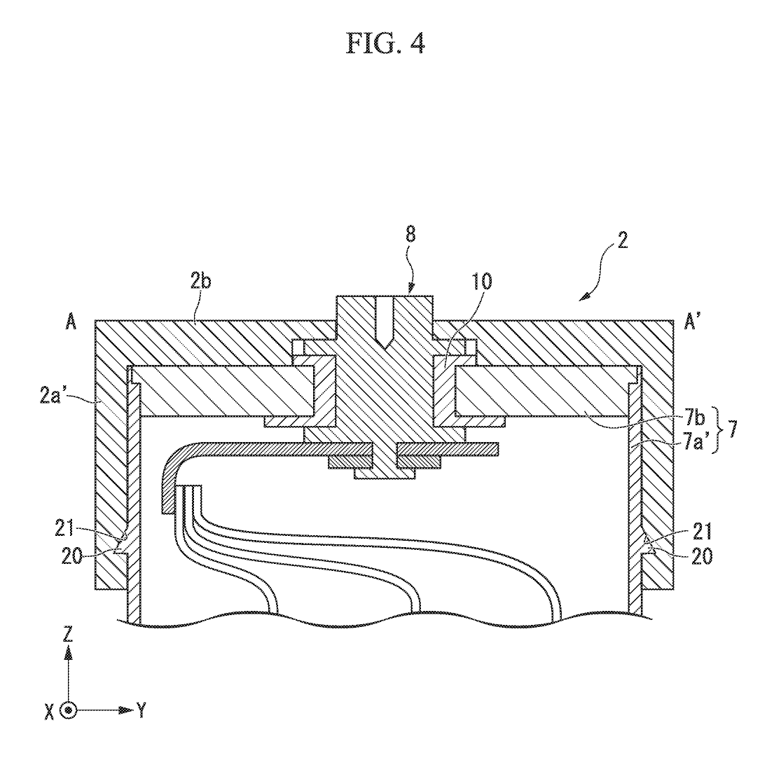

In the battery module of the first embodiment, the attachment 2 can cover the battery cell 1 firmly by the effect of the frictional portion 18. As an alternative to the use of the frictional portion 18, it is possible to engage the protruding portion 20 with the recessed portion 21 as shown in the modified embodiment shown in FIG. 4 to fix the attachment 2 to the battery cell to constitute a battery module 100.

The embodiment shown in FIG. 4 is similar to that shown in FIG. 1, except for the use of a case main body 7a′ that is formed by forming a protrusion 20 in the case main body 7a in FIG. 1 and the use of an attachment-side part 2a′ that is formed by forming a recess portion 21 having a shape corresponding to the protruding portion 20 in the inner surface of the attachment-side part 2a. Therefore, detailed explanations for the same reference symbols are omitted here.

In the modified embodiment, shape of the protruding portion 20 has the same wedge shaped cross section in the YZ plane. The wedge shape is formed such that the width in the Y direction of the cross section of the case main body 7a′ in the YZ plane increases towards the direction (−Z direction) to which the attachment 2 is inserted at the time of forming the battery module 100. Therefore, once the protruding portion 20 and the recessed portion 21 are engaged, the battery cell 1 and the attachment 2 are fixed more firmly than the case of using the frictional portion 18. Therefore, the resistance section 80 is fixed to the cathode terminal 8 and the battery case 7 more stably than the case of using the frictional portion 18, thereby providing a battery module 100 of further improved battery performance.

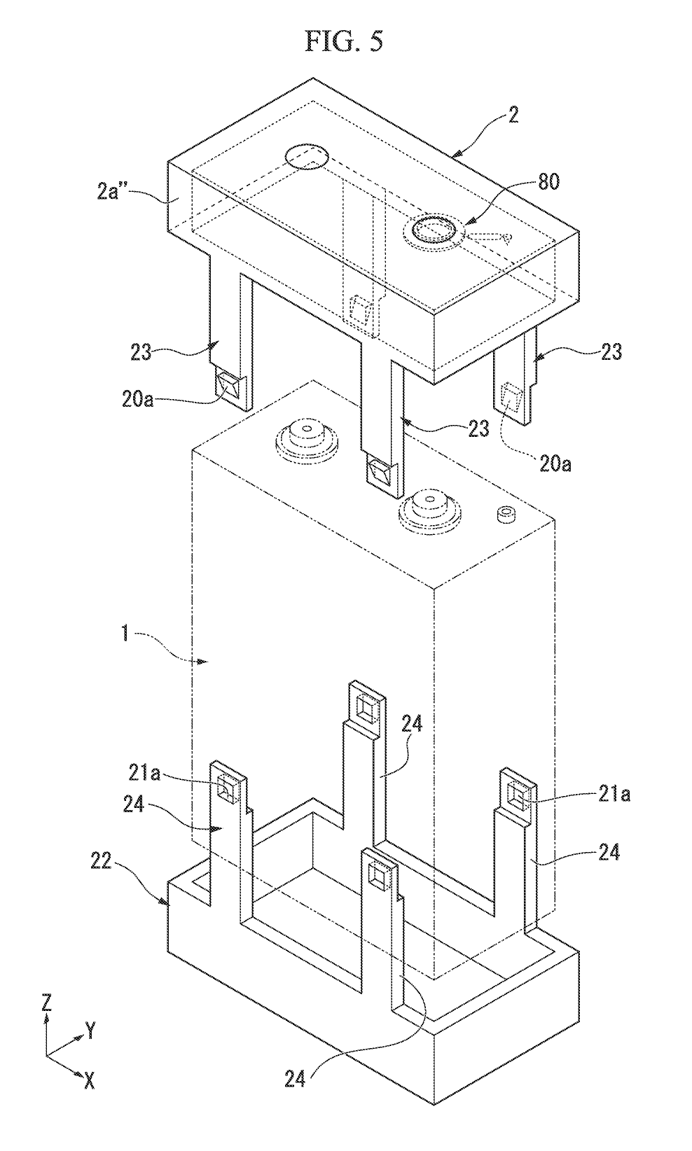

In FIG. 4, wedge shaped protruding portion 20 is formed in the case main body 7a′ and a recessed portion 21 having a shape corresponding to the protruding portion 20 is formed in the attachment-side part 2a′. Alternatively, it is possible to form a wedge shaped protruding portion in the attachment-side part 2a and recessed portion having a shape corresponding to the protruding portion in the case main body 7a. In this case, it is preferable to form the shape of the protruding portion such that the width in the Y direction of the cross section of the attachment-side part 2a in the YZ plane decreases towards the direction (−Z direction) to which the attachment 2 is inserted at the time of forming the electrode module 100. A modified embodiment as shown in FIG. 5 may be employed from such point of view.

The battery module 100 shown in FIG. 5 has a attachment-side part 2a″ in which two first arms 23 are elongated in the −Z direction from each side in the XZ plane of the attachment-side part 2a shown in FIG. 1. A protruding portion 20a is formed in the end of the arm 23, where the protruding portion 20a has the above-described wedge shape where a width along Y direction of the cross section of the attachment-side part in the YZ plane decreases towards the direction (−Z direction) to which the attachment is inserted (the attachment 2 equipped with the attachment-side part 2a″ is referred to as the first attachment). A second attachment 22 is prepared to have a shape similar to that of the first attachment except for the below-described difference. As the difference, two penetration holes for the electrode terminals that exist in the first attachment are not formed. A recessed portion 21 a having a corresponding shape is formed as an alternative to the protruding portion 20a (here, the arm in which the recessed portion 21a is formed is referred to as a second arm 24). Since the other constitutions are similar to those of FIG. 1, detailed explanations are omitted for the same reference symbols.

In the constitution shown in FIG. 5, the battery cell is covered by the first attachment from the upper side and is covered by the second attachment from the bottom side, and the first attachment and the second attachment are fixed by engaging the protruding portion 20a with the recessed portion 21a formed respectively therein. Lengths of the first arm 23a and the second arm 24 along the Z direction are designed such that resistance section 8 may constitute an electric path between the cathode terminal and the battery case 7 in the fixed state. According to this constitution, in addition to the effects described with respect to FIG. 4, there is an additional effect such that the battery cell is effectively protected from unexpected shock or the like since the battery cell can be sandwiched firmly by the first attachment and the second attachment.

According to the above-described constitution of the battery module 100 of the first embodiment and its modified embodiments, electrode terminal 8 and the sealing section 17 of the battery cell 1 and corresponding resistance section 80 of the attachment 2 are constituted as described above. Therefore, the below-described effects can be exerted.

As the electrode module 100, movement of the attachment 2 relative to the battery cell 1 is restricted by friction caused between the inner face of the attachment-side part and a portion of the battery case 7 being in contact with the inner face. Therefore, the attachment 2 is not likely to be detached from the battery cell 1, and the first conducting section 81 and the second conducting section 82 can be pressed stably. Thus, it is possible to ensure reliability of the electrical connection between the battery case 7 and the cathode terminal 8. Therefore, the battery module 100 of the present embodiment can be provided with excellent battery performance.

The resistance section 80 is fixed by being embedded in the plane in the side of the recessed portion 2c of the attachment ceil plate 2b of the attachment 2. The resistance section 80, thus being disposed inside the attachment 2, is protected from damage caused by interruption with the material outside the battery module. For example, a possibility of damage of the resistance section 80 at the time of conveying the battery module 100 is reduced. Therefore, the battery module 100 of the present embodiment may maintain excellent battery performance.

Further, since the first conducting section 81 of the resistance section 80 has a protruding shape, its end is guided by the inner face of the engagement portion (recess) 19 of the sealing section 17 at the time of engaging the battery cell and the attachment 2. Further, the cathode terminal 8 is guided by the penetration hole of the second conducting section 82, and the resistance section 80 is engaged with the cathode terminal 8 and the battery case 7. Therefore, a lot of labor is not required for setting of the position of the resistance section, the cathode terminal 8, and the battery case. As a result, the battery module 100 can be produced effectively.

When the battery module 100 is formed by covering the electrode cell 1 with the attachment 2, the resistance section 80 is electrically connected to the cathode terminal 8 and the battery case 7 (more precisely, sealing section 17 connected to the battery case 7) automatically by one tough operation. Therefore, it is possible to improve production efficiency and to provide the battery module 100 having excellent battery performance.

### Second Embodiment

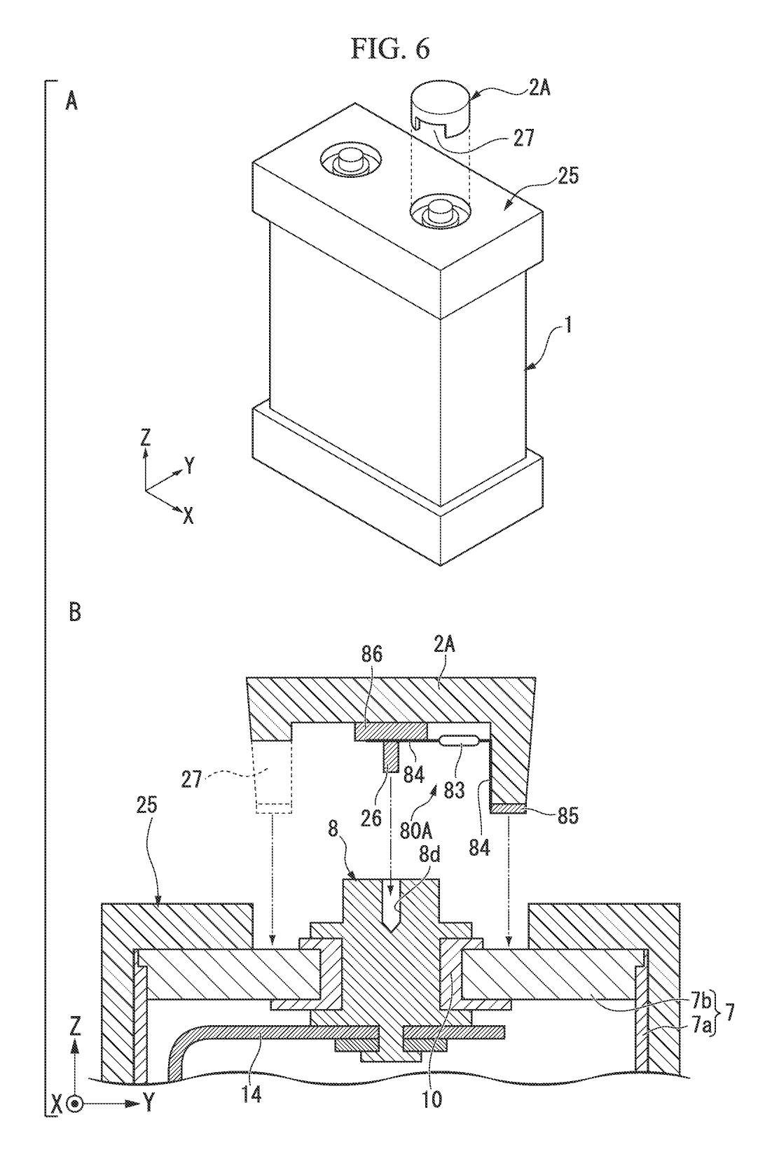

A battery module of a second embodiment is explained with reference to FIG. 6. In the first embodiment and its modified embodiments, where the attachment 2 is fixed to the battery cell 1, for example, by friction with the case main body 7a of the battery cell 1. The attachment 2 is downsized in this embodiment. The attachment 2A used in this embodiment is not fixed to the case main body of the battery cell 1, but is fixed to the lid 7b. That is, this embodiment is different in the constitution of the attachment 2A, and the other parts are similar to those of the first embodiment and its modified embodiments. Therefore, an explanation of these parts is omitted by using the same reference symbols.

The attachment may have analogous appearance as the attachment 2. Here, to show an embodiment that is fixed while covering the cylindrical cathode terminal 8, attachment-side part of the attachment main body 2A has a tubular shape and the attachment ceil plate has a circular shape that are different from the shape of attachment-side part 2a and attachment ceil plate 2b of the attachment 2. That is, a recessed portion is also formed in the attachment 2A by joining the whole periphery of the attachment ceil plate by the attachment-side part.

A notch 27 is formed in the attachment-side part of the attachment 2A. When a wiring such as bus bar is connected to the cathode terminal 8, the notch 27 acts as a space for passing the wiring theretrough. Like as the attachment 2 used in the battery module of the first embodiment, the attachment 2A is provided with a resistance section 80A that is embedded and fixed in the inner face having a shape (here, tubular shape) formed by the attachment ceil plate and the attachment-side part. That is, the resistance section 80A is integrated with the attachment main body 2A.

Like as the resistance section 80, the resistance section 80A includes: a first conducting section 85 that is made of metal and in physical contact with the lid 7b; a second conducting section 86 that is made of metal and in physical contact with the cathode terminal 8; and a resistance body 83 that is disposed between the first conducting section 85 and the second conducting section 86 and is connected to these sections, and provides high resistance value to the electric path between the first conducting section 85 and the second conducting section 86. The resistance body 83 may be connected physically to the first conducting section 85 and the second conducting section 86 directly, or may be connected to the first conducting section 85 and the second conducting section 86 via a wiring 84.

A protruding guiding portion 26 is formed in the battery module of this embodiment so as to fix the attachment 2A to the electrode terminal (here, the cathode terminal) provided with a thread hole. The guiding portion 26 has a substantially same but slightly larger diameter as the thread hole 8d of the cathode terminal 8. The guiding portion 26 has a shape extending from the attachment ceil plate of the attachment 2A while avoiding contact with the second conducting section 86 that is in physical contact with the upper face of the cathode terminal 8. Material of the guiding section 26 may be selected from silicone rubber, plastic resin or the like. Therefore, the attachment ceil plate and the guiding section 26 may be molded integrally. The attachment-side part may be molded integrally with the attachment ceil plate and the guiding section 26.

The first conducting section 85 is fixed to the bottom plane of the attachment-side part of the attachment 2A such that the first conducting section 85 is made physical contact with the lid 7b when the attachment 2A is pressed and fixed by inserting the guiding section 26 into the cathode terminal 8.

According to the above-described constitution, the battery module of this embodiment can exert effects similar to those of the battery module of the first embodiment. Although battery cells generally have various dimension and shapes, the attachment 2A may be mounted to the various battery cell provided that the cathode terminal 8 of the battery cell has the same thread hole 8d. Therefore, compared to the battery module of the first embodiment, the battery module of the present embodiment has a wide range of application. Thus, advantage in productivity is further improved.

Like as the above-described modified embodiment of the first embodiment, a third attachment 25 having a shape similar to that of the attachment 2 (but lacking the resistance section 80) may be mounted to the battery cell 1 so as to protect the battery cell 1.

In this case, dimension of the penetration hole for the cathode terminal is designed arbitrarily such that the attachment 2A can exert the above-described effect. Where the dimension is designed to be substantially the same but is slightly smaller than the cross-sectional shape of the attachment 2A in XY plane, the attachment 2A is fixed not only by the guiding portion 26 but also by the frictional force or the like with the third attachment 25, thereby ensuring excellent battery performance.

Although a lithium ion rechargeable battery was used as an example in the explanation of the above-described embodiments and the modified embodiments, the present invention is not limited to this type. The present invention may be applied to batteries that utilize other active materials or primary batteries provided that the batteries utilize a stacked electrode body. The present invention can be applied not only to the stacked type batteries but also to the wound type batteries without departing from the scope of the invention. Shapes of the battery case and the electrode terminals are not limited to angular or tubular shapes but may be modified to any shapes by property modifying the shape of attachment 2 or the like.

In some occasion depending on the selected combination of cathode active material, the battery has a constitution in which the resistance section 80 is not electrically connected between the cathode terminal 8 and the battery case 7, but the resistance section 80 is electrically connected between the anode terminal and the battery case. In this case, the above-described explanation related to the cathode terminal 8 may be replaced to the explanation for the anode terminal 9. That is, the present invention can be applied to the case in which a resistance body is electrically connected between the anode terminal and the battery case.

### INDUSTRIAL APPLICABILITY

The present invention relates to a battery module including: a battery cell having an electro-conductive battery case, electrode terminal that is exposed outside the battery case, and electrode plates; and an attachment that has a first conducting section, a second conducting section, and a resistive material that is disposed between the first conducting section and the second conducting section and that is electrically connected to the first conducting section and the second conducting section, wherein the attachment is attached to the electrode cell, and the first conducting section is electrically connected to the battery case and the second conducting section is electrically connected to the electrode terminal at the time of attaching the attachment. According to the present invention, it is possible to provide a battery module having excellent battery performance while improving the production efficiency.

### EXPLANATION FOR SYMBOLS

1: Battery cell
2, 2A: attachment (first attachment)
2a, 2a′, 2a″: attachment-side part
2b: attachment-ceil plate
2c: recessed portion
2d: penetration hole for cathode terminal.
2e: penetration hole for anode terminal.
3: cathode plate (electrode plate).
3a: collector member for cathode.
3b: cathode active material.
4: anode plate (electrode plate).
4a: collector member for anode.
4b: anode active material
5: separator
6: stacked electrode body
7: battery case
7a, 7a′: case main body
7b: lid
7c: liquid pouring hole
8: cathode terminal (electrode terminal)
8a: axial portion
8b: first connecting portion
8c: second connecting section
8d: thread hole
9: anode terminal (electrode terminal)
10: insulation resin for the cathode terminal
11: insulation resin for the anode terminal
12: cathode tab
13: anode tab
14: cathode lead
15: securing member
16: securing aid member
17: sealing section
18: frictional portion
19: engagement portion (recessed portion)
20, 20a: protruding portion
21, 21a: recessed portion
22: second attachment
23: first arm
24: second arm
25: third attachment
26: guiding section
27: notch
80, 80A: resistance section
81, 81a: first conducting section
82: second conducting section
82a: plate thickness increasing section
83: resistance body
84: wiring.
85: first conducting section.
86: second conducting section.
100: battery module.

1. A battery module comprising: a battery cell having an electro-conductive battery case, an electrode terminal that is exposed outside the battery case, and electrode plates; and an attachment that has a first conducting section, a second conducting section, and a resistive material that is disposed between the first conducting section and the second conducting section and that is electrically connected to the first conducting section and the second conducting section, wherein the attachment is attached to the electrode cell, and the first conducting section is electrically connected to the battery case and the second conducting section is electrically connected to the electrode terminal automatically at the time of attaching the attachment.

2. The battery module according to claim 1, wherein the attachment comprises an attachment ceil plate having a flat plate shape, an attachment-side part that is connected to the whole periphery of the attachment ceil plate, and forms a recessed portion with the attachment ceil plate, wherein the resistive material is disposed in an inner side of the recessed portion.

3. A battery module according to claim 2, wherein a cross sectional shape of the recessed portion is substantially the same as a cross sectional shape of the battery case, and the attachment is attached to the battery case by elastic deformation of the attachment-side part.

4. The battery module according to claim 3, further comprising a second attachment that has a substantially same shape as that of the attachment, wherein the attachment is attached by sandwiching the battery cell by the attachment and the second attachment and engaging the attachment and the second attachment.

5. The battery module according to claim 2, wherein the attachment further comprises a guiding section in the recessed portion to extend from the attachment ceil plate, whereon a hole is formed in the electrode terminal in the exposed portion, and the attachment is performed by fixing the attachment to the battery cell by inserting the guiding section in the hole.

6. The battery module according to claim 1, wherein the electrode terminal includes an axial portion, and a connecting portion that extends to the direction of cross section of the axial portion and that is formed in integral with the axial portion, and resistance of an electric path between the electrode terminal and the electrode plate is reduced by providing an electric path from the electrode plate to the connecting portion.

7. The battery module according to claim 6, wherein the electrode terminal is a cathode terminal.

8. The battery module according to claim 2, wherein the electrode terminal includes an axial portion, and a connecting portion that extends to the direction of cross section of the axial portion and that is formed in integral with the axial portion, and resistance of an electric path between the electrode terminal and the electrode plate is reduced by providing an electric path from the electrode plate to the connecting portion.

9. The battery module according to claim 3, wherein the electrode terminal includes an axial portion, and a connecting portion that extends to the direction of cross section of the axial portion and that is formed in integral with the axial portion, and resistance of an electric path between the electrode terminal and the electrode plate is reduced by providing an electric path from the electrode plate to the connecting portion.

10. The battery module according to claim 4, wherein the electrode terminal includes an axial portion, and a connecting portion that extends to the direction of cross section of the axial portion and that is formed in integral with the axial portion, and resistance of an electric path between the electrode terminal and the electrode plate is reduced by providing an electric path from the electrode plate to the connecting portion.

11. The battery module according to claim 5, wherein the electrode terminal includes an axial portion, and a connecting portion that extends to the direction of cross section of the axial portion and that is formed in integral with the axial portion, and resistance of an electric path between the electrode terminal and the electrode plate is reduced by providing an electric path from the electrode plate to the connecting portion.
